(19) United States
(12) Patent Application Publication
(10) Pub. No.: US 2017/0206455 A1
(43) Pub. Date: Jul. 20, 2017

(54) METHOD FOR PROCESSING KNOWLEDGE OR INFORMATION, DEVICE, AND COMPUTER PROGRAM

(71) Applicant: KNOWRELSYSTEM, INC., Kanazawa-shi, Ishikawa (JP)

(72) Inventor: Keisuke NAKAMURA, Kanazawa-shi, Ishikawa (JP)

(21) Appl. No.: 15/324,634

(22) PCT Filed: Nov. 5, 2014
(86) PCT No.: PCT/JP2014/005571

§ 371 Date: Jan. 6, 2017

(51) Int. Cl. G06N 5/04

(52) U.S. Cl. CPC G06N 5/04

(57) ABSTRACT

To use a computer to automatically process knowledge in the same manner as Prolog, the knowledge being expressed in a format wherein variables are embedded in natural language, and to achieve comprehensive deduction and solution searching at the predicate logic level. As in the input of Prolog “facts,” “rules,” and “goals,” in the present invention a person uses character types, delimiters, or escape characters to distinguish the constant portions and the variable portions of content that is equivalent to “literal” in Prolog and inputs the content into a computer. The computer performs automatic unification and/or automatic derivation on text included in the input while treating variables as material that could span the boundaries of the subject, predicate, etc. of the text.

### TECHNICAL FIELD

The present invention relates to a method for processing knowledge or information: especially to a method, a device and a computer program for processing knowledge or information expressed by natural language “as it is”.

### BACKGROUND ART

One of the methods to process knowledge or information, especially as a method to process the knowledge or information expressed by natural language “as it is” is following Patent Literature 1, which conducts such as a deduction of the same level of logic-oriented programming language, PROLOG based on knowledge or information expressed by the natural language (e.g., answering to a yes-no question by syllogisms, i.e., as closed questions), a solution search (e.g., obtaining a solution set corresponding to a designated condition, i.e., as open questions) or a procedural interpretation by an automatic unification process, which may be just a unification or an automatic derivation process, which may be a backward reasoning with backtracking).

Establishment of the technique described in the Patent Literature has enabled the sentences made by a user on their own words naturally, which means without concerning about the ontology or standardization of a notation method or an order of cases appearing in a sentence, or articles of the natural language released on the internet by people all over the world to become a knowledge source of the deduction or the solution search (i.e., such as an automatic unification process and an automatic derivation process) as it is by just citing or referencing to (e.g., copying and pasting, designating URLs). Thus Patent Literature 1 has been expected to achieve a great improvement in use and application of information or knowledge of the natural-language level, which is not formalized at all, by lay persons (e.g., those who are not experts of the information processing or knowledge processing yet have knowledge of the “variable” taught in a math class at a junior high school or higher).

However, practical use of the technique of the Patent Literature 1 has several problems. The problem is that a computer should list up a plurality of solution candidates such as “($X, $Y, $Z)=(Taro and Jiro, Saburo, curry) and (Taro, Jiro and Saburo, curry)” as the solution candidates of a variable group ($X, $Y, $Z) based on “Taro and Jiro and Saburo like curry” and also be able to check and test the possibility of each solution comprehensively, instead of listing up a sole candidate to conduct the deduction or solution search from the knowledge source (i.e., to conduct the backward reasoning, which may be the automatic derivation process, with the unification, which may be automatic unification process in PROLOG) in case that a variable expressed as “X” (an example of a variable identifier of an em capital character (character type)), “$X” (an example of an em or en escape character “$” and a variable identifier “X”), “$ {productive agent}” (an example of the escape character ($) and a delimiter ({ . . . }), and a variable identifier “productive agent”) and the like are embedded in a sentence of the natural language and expressed as “$X and $Y like $Z”, unlike a conventional PROLOG, in which “a verb (subject, object, when, where)” and a case structure are separated with commas, whereby each role (case) is determined by the order of an “argument”.

This requires the computer to try all the unifications that may have the possibility of a plurality of unifications from a viewpoint that is different from the problematic viewpoint (such as orthographical variants) of Patent Literature 1 discussed above on such a fact (“FACT” of PROLOG as “Taro and Jiro and Saburo like curry”. This viewpoint is also different from any viewpoint that is necessary to cover a plurality of solution candidates by a normal backtrack of PROLOG, which is only to cover a range restricted by the case structure.

This has prevented automatic process of knowledge (which may be the fact (=FACT), the rule or goal) expressed by embedding variables to the natural languages like PROLOG (it is referred as “difficulty A”), since this is a further complicated problem for the backtrack for the comprehensive automatic derivation process for the automatic unification process with the fact expressed by the natural language (the fact including a variable: e.g., “$X is $X”) or the fact without the natural language (e.g., “Taro and Jiro and Saburo like curry”). This comprehensive automatic derivation process also may be for spreading to the unification with the natural language expression, which includes a variable to be restricted in many cases. This expression corresponds to a head part of a Horn clause (rule) of PROLOG (i.e., the unification of the expressions that may include a variable with each other) or a variable of a body part (a variable has the same scope) of a restriction value (e.g., X←Taro and Jiro or the like) by the unification.

In addition, as described in Patent Literature 1, an applicational implementation with robustness against the spelling inconsistency and a form of the hybrid knowledge expression applied to many natural language systems currently has prevented a clear display and instinctive trace of the derivation flow of the knowledge aggregation, which is a basis of an inferring result. This applicational implementation also has been not so useful for learning the predicate logic or personal study of philosophy, policy or the like. Here, the spelling inconsistency means analogy application to the derivation process of the knowledge based on a superficial/meaning similarity in the sentence, and a form of the hybrid knowledge applied to many natural language systems means a combination of rewriting and inferring rule, dictionary (e.g., semantics and pragmatics), and corpus analysis (e.g., n-gram statistics, co-occurrence frequency, co-occurrence probability expression).

### PRIOR ART DOCUMENTS

### Patent Literature

Patent Literature 1: Japanese Patent Laid Open 2006-024045

### SUMMARY OF INVENTION

### Technical Problem

One of the technical problems to be solved by the present invention is problem 1) overcoming the “difficulty A” in its practical use as mentioned above and enabling the computer to process the knowledge expressed by embedding a variable to the natural language automatically like PROLOG. This enables the comprehensive deduction or solution search (which may be the automatic unification process, the automatic derivation process, backward reasoning therefor, backtracking) at the predicate logic level from the knowledge source of the natural language. Here, the automatic derivation process may require rewriting of a variable of the head part after the unification of the body part and rewriting of a variable in “further right side” of a literal (in a “command” as well if further conducting a command operation by a “procedural interpretation”) in accordance with the unification of the “further left side” of the literal in the head part and the body part. This occurs with further conducting the procedural interpretation of the body part.

In addition, other technical problems are: problem 2) utilizing more broadly the advantage of the design that a variable is not restricted by the case structure; problem 3) accelerating the process under a condition, which is free but consequently severe in a sense, without restriction out of the case structure; and problem 4) displaying the argument (a proofing process, a reasoning path, knowledge aggregation that is used, or the like) clearly for such usages as learning and study.

### Solution to the Problem

The present invention has been conceived in view of these problems. The invention defined in claim 1 provides a processing method for causing a computer to automatically execute all of or a part of a function of a logic programming language PROLOG, the method comprising:

manually inputting “fact”, “rule” or “goal” of PROLOG to the computer in discerning a constant part and a variable part corresponding to “literal” of PROLOG (referred as “sentence” hereafter) by a character type, a delimiter or an escape character; and

by computer, executing an automatic unification process, an automatic derivation process or both of them in the sentence included in the input of the “fact”, “rule” or “goal”, handling a variable as what may straddle a boundary of a subject clause, a predicate clause, a subject, a predicate, an object, a complement, a modifier of an inflectable word or a sentence.

Here, the phrase above, ‘manual input of “fact”, [ . . . ] to “literal” of PROLOG (referred as “sentence” hereafter) by a character type, a delimiter or an escape character’, includes human direct input to a field of an application software (processing system) of the present invention. Such an input also includes the one after a command prompt (whether through or not through a front-end processor). This kind of actions also include copying and pasting or cutting and pasting from such as an Internet browser and a sentence editing software, and reading, inciting or referring to a text file stored and saved separately.

Plus, the phrase above, “handling a variable as what may straddle a boundary of a subject clause, a predicate clause, a subject, a predicate, an object, a complement, a modifier of an inflectable word or a sentence”, includes the mode that handles a variable as what may straddle the boundary (or an explicit pause) of the case structure, which may include what corresponds to a hierarchical structure of a syntax analysis result or a semantic analysis result, with an explicit punctuation via such things as an auxiliary verb of Japanese language or a preposition of English language. This handling also regards a variable as, for instance, what may straddle the boundary between S and V, V and O, and V and C of SV form, SVO form SVOO form or SVOC form of English and such other languages, or the boundary between compound sentences and complex sentences. The mode that does not handle a variable as such can be included here. In these cases, the solution candidate that may be in a variable includes: a whole sentence; a random partial character string which is extracted from certain character strings consisting of the whole sentence without regarding to a unit of the separation of a grammar structure as the sentence; the compound sentence and the complex sentence with a hierarchical reference structure; the whole length of such a longer article as theses; and a certain partial character string of them. Note that this refers to a case of handling what may straddle the “boundary between sentences” and thus a linefeed code, a tab code or the like, can be used in case of handling an aggregation of the knowledge source (e.g., reading, writing, referring to aggregation of knowledge source collected in a file), for separation is required between the knowledge sources other than the boundary between sentences.

This enables a computer to process automatically knowledge or information expressed by embedding a variable into the natural language and such things in a normal sentence form as a unified knowledge source with a sufficient possibility of achieving a practically mutual utilization between those items without discerning them (which means overcoming of the “difficulty A”).

Achievement of the “sufficient” possibility of the “practically” mutual utilization requires 1) convenience of a search formula (an expression to designate a pattern), 2) sufficient precision (accuracy of the solution), and 3) sufficient reproducibility (comprehensiveness for extracting the solution candidate), all of which should be provided as a search processing system for the automatic processing executed by the computer. The present invention enables (and achieves the convenience) a variable (that may be a plurality of types and for a plurality of times) to be embedded in a free position in the sentence (i.e., not restricted by grammar or separation of meanings), with basically following the knowledge processing procedure (and a knowledge interpreting policy therein) of PROLOG. This avoids the risk of reducing the precision (or the accuracy of the solution), which may be caused by the hybrid knowledge processing procedure in other processing systems (and a complicated knowledge interpreting policy corresponding to the hybrid processing procedure). This reduction of precision occurs with “handling a variable as what may straddle a boundary of a subject clause, a predicate clause, a subject, a predicate, an object, a complement, a modifier of an inflectable word or a sentence”, an inappropriate mismatch (or discrepancy of a regular expression) from an enforced division of the designated pattern by a separating expression (e.g., punctuation point, punctuation, bracket, comma, and period) of the natural language or a modified phrase (an adjectival phrase, an adverb phrase, an optional case expression). The present invention can prevent this risk and achieve a certain repeatability (comprehensiveness in extraction of solution candidate) in a superficial character string expression (between the research formula and the knowledge source), in which the case structure is not explicit. In addition, this can achieve an integrated and continuous citation and extraction (as the solution candidate for a variable), which hardly damages an appropriate context (anteroposterior character strings) of the natural language as the knowledge source, and thereby it facilitates confirmation and testing of substantive soundness (appropriateness of reasoning and inferring process) of inferring by the transparency and simplicity. Plus, the user gets realistic secure feeling that the reasoning is always clear. Eventually, the users fully enjoy the advantage of the design that a variable is not restricted by the case structure. (Additionally, the user does not need to know the case structure rule, like the order of appearance, and also he/she is free from the uneasiness that the order of the parameter might be wrong).

Incidentally, as the present invention is intended for the Japanese language (whose one character has much information volume and the sentences have no spaces between words) primarily, the character is handled as a processing unit and a separating unit in many cases. For English (one character has less information volume and a sentence has many characters with a space between words) or such languages, the same process can be done using the word separated by spaces as the unit.

In addition,

claim 2 provides the processing method as claimed in claim 1, comprising, in the automatic unification process:

recursively repeating a unification of patterns (whose constant part and variable part are distinguished by a character type, a delimiter or an escape character) as sentences that may include variables and a sentence that does not include variables until it comes to have no variable in a constant manner;

calculating a longest matching solution (ex. TaroandJiro) of the variable (ex. $X) that appears in the pattern (ex. $Xand$Ylike$Z) firstly (or lastly), followed by storing each status ($X=TaroandJiro>TaroandJi>Taroand>Taro>Ta>Null) of the solutions, which is a base condition to generate a new pattern, as to each of the new pattern (ex. “TaroandJiroand$Ylike$Z”>“TaroandJiand$Ylike$Z”>“TaroAndand $Ylike$Z”>“Taroand$Ylike$Z”>“Taand$sYlike$Z”>“and$Ylike$Z”) obtained by assigning the process (ex. “TaroandJiro>TaroandJi>TaroandJi>Taroand>Taro>Ta>Null) eliminating characters of the character string of the longest matching solution from its rear (or its beginning) to a null character in the eliminating process; and

obtaining different answers (e.g., Answer 1=($X=TaroandJiro, SY=Sabro), answer 2=($X=Taro, SY=JiroandSaburo) of different unifications by integrating the status of each unified halfway solution (e.g., truth ($X=TaroandJiro, $Y=Saburo), truth ($X=Taro,$Y=JiroandSaburo)) when there is no more variable.

Here, “(or lastly)” corresponds to “(or its beginning)”, which means that it is required to eliminate the character string from its beginning when assigning a variable from the lastly appearing one.

This enables providing a comprehensive solution (an aggregation of further narrowed solution candidates) by testing the status of each solution candidate certainly covering all the possibilities from the longest matching solution to the shortest matching solution.

In addition,

claim 3 provides the processing method as claimed in claim 2, comprising:

gradually eliminating characters just until a shortest matching solution obtained separately, instead of gradually reducing to the null character.

This makes the calculation of the solution search from a length shorter than the shortest match solution to the “null” character, which may accelerate the automatic process thereby.

In addition,

claim 4 provides the processing method as claimed in claim 2 or 3, comprising:

gradually eliminating until the character gets null;

gradually eliminating the characters until the character gets null and the longest matching solution includes one character C that is a fixed character appearing just after (or just before) the variable appears first (or last) in the pattern; and

eliminating partial character strings ranging from the last (or first) to the first C met of the longest matching solution, including the C;

wherein this one character C is the first (or the last) character C of the solution candidate that is assigned to the other variable as a solution candidate when the character appearing just after (or just before) is the other variable and the solution is not a null character.

Here, “(or the last)” corresponds “(or just before)”, which means to require elimination from the beginning when assigning from a variable that appears last.

This enables cutting the list-up of the solution candidates that do not match the fixed character just after (or just before) a variable and the search premising the solution candidates, which may thereby accelerate the automatic process.

In addition,

claim 5 provides the processing method as claimed in any one of claims 1 to 4, comprising, in the automatic unification process or the automatic derivation process:

obtaining a restriction information that is the “goal” (including a “sub goal”, the same applying hereafter);

obtaining the restriction information about each sentence constituting the “goal” independently; and

giving a return value true and its product set when the product set of each restriction info nation is not empty.

Here, the restriction information is the information indicating about whether such solution candidate has been tried to and should be assigned to each variable simultaneously. The restriction information indicating one way to restrict each variable is able to be expressed in a list form such as “thevariablename1=thevalue1, thevariablename2=thevalue2, . . . , thevariablenameN=thevalueN” by interpreting comma as an AND join, while a multiple restriction way is able to be expressed in such a list set or in a form where common parts between multiple restrictions are factored out by defining AND/OR join, instead of comma or in a conjunctive normal form or in a selective normal form that is standardization of the whole multiple restrictions.

In case of a question style in which there are a plurality of patterns (sentences) to be met simultaneously and the same solution should enter variables that have the same name between the patterns (sentences) (e.g., in case that there are inquiries about such AND join from the user or the body part of the rule has a plurality of sentences), no useless repetition of the search process on a great amount of whole sentences is necessary for the results of each unification of the pattern on the left side regarding the pattern on the right side of the rule. This enables avoiding inefficiency to conduct a depth-first search while backtracking the body part (more dominant inefficiency in a form where a variable is embedded in natural language) and simplifying the process per pattern to be met simultaneously. Also, this makes comprehensible and simple the displays or the test (of completeness or soundness) of the inferring process. In addition, this enables preventing the ordering (of sentences of the body part), which is unnecessary for intuition that is necessary for the meaning of the rule and should not be defined, from causing a side effect on the inferring process.

In addition,

claim 6 provides the processing method as claimed in any one of claims 1 to 4, comprising, in the automatic unification process or the automatic derivation process:

obtaining a restriction information that is “goal”;

defining an existing restriction information as null first;

reducing recursively a sentence aggregation included in the “goal”, by executing an automatic calculation regarding whether the one sentence can be true under application of an existing restriction information and also additional restriction information to be true;

eliminating the one sentence while adding the additional restriction information to the existing restriction information; and

defining the existing restriction information as “goal” when the sentence aggregation keeping possibility to be true turns to an empty set.

Here, “reduces recursively” means, for example, executing the process to conduct a recursive call by the C language, or by performing similar recursive process through a stack structure (an arrangement of a structure and stack pointer or the like) for the depth-first search originally declared and defined so that the deeper the recursion is, the smaller the sentence aggregation becomes and the more complicated the restriction information becomes (more variables are restricted and a range of values to be restricted is narrowed more).

This enables simply converting a question of processing automatically an open question constituted with the AND join of multiple patterns to be met simultaneously expressed in a form by embedding a variable to the natural language into a partial question having simpler and more recursive isotypic structure to simplify the display and test (of completeness and soundness) of the inferring process.

In addition,

claim 7 provides the processing method as claimed in any one of claims 1 to 6, comprising, in the automatic unification process or the automatic derivation process:

unifying the pattern not including a variable and the fact not including a variable;

returning true when the pattern and the fact match each other as a character string; and

returning false when the pattern and the fact do not match each other as a character string.

This enables the search to be conducted simply and promptly.

Incidentally, when “the fact not including a variable” includes multiple sentences separated by such as a point, it is also possible to provide a mode in which “match as a character string” may include a case that the character string of the pattern matches a part of the character string of the fact.

This enables multiple information in the same form can be expressed collectively as a single fact to be a subject of the search. Additionally, any ordering of multiple elements (e.g., volume, preciousness, oldness . . . or the like) can be expressed with ease.

In addition,

claim 8 provides the processing method as claimed in any one of claims 1 to 7, comprising, in the automatic unification process or the automatic derivation process:

unifying the pattern not including a variable and the head not including a variable;

when the pattern and the fact match each other as a character string, returning the result of application of processing method described in claim 5 or 6 wherein defining body part of the Horn clause as the sub goal; and

when the pattern and the fact do not match each other as a character string, returning false.

This provides sound mechanical interpretation when a head of the rule expressed in the form of embedding a variable into the natural language does not include a variable, a seamless, comprehensible, simple and united process mechanism, and explanation of a corresponding inferring process.

In addition,

claim 9 provides the processing method as claimed in any one of claims 1 to 8, comprising, in the automatic unification process or the automatic derivation process:

unifying a pattern not including a variable and a Horn clause having the head part including a variable;

on each restriction information obtained by using the pattern as the “constant character string” in the processing method claimed in any one of claims 2 to 4 and using the head part as the “pattern” in the same processing method,

returning true when what can be true exists after the restriction information is applied to the body part of the Horn clause and the resulted body is processed as “sub goal” of the processing method claimed in claim 5 or 6; and

returning false if not.

This enables the process of true or false judgment to accelerate itself by limiting the restriction range of variables of the body part beforehand when the head of the rule expressed in a form by embedding a variable to the natural language includes a variable and the pattern activating this rule does not include a variable.

In addition, this can provide sound mechanical interpretation, a seamless, comprehensible, simple and united process mechanism, and explanation of a corresponding inferring process.

In addition,

claim 10 provides the processing method as claimed in any one of claims 1 to 9, comprising, in the automatic unification process or the automatic derivation process:

unifying a pattern including a variable and a fact not including a variable; and

returning a result processed by executing processing by using the pattern as the “pattern” in the processing method claimed in any one of claims 2 to 4 and by using the fact as the “constant character string” in the same processing method.

This enables providing a basic structure for overcoming the “difficulty A” in a simple way, for all the solution candidates (for each variable) between the pattern and (static) fact are picked up and returned as the “results”. This also enables easy implementation not only of visualization and testing of the inferring process but also of study such as modification of the rule or the like via the user.

In addition,

claim 11 provides the processing method as claimed in any one of claims 1 to 10, comprising, in the automatic unification process or the automatic derivation process:

unifying a pattern including a variable and a Horn clause having a head part not including a variable;

returning true together with restriction information (C)

in case that the restriction information (C) exists which takes a true result processed by
using said pattern as the “pattern” in the processing method claimed in any one of claims 2 to 4, and
using the head part as the “constant

character string” in the same processing method,

and that the result processed by taking the body part of the Horn clause as “sub goal” of the processing method claimed in claim 5 or 6 is true.

This enables providing a basic structure for overcoming the “difficulty A” in a simple way, for all the solution candidates (for each variable) between the pattern including a variable and the head (not including a variable and static) are picked up and returned as the “results”, and to easily implement not only visualization and testing of the inferring process but also study such as modification of the rule or the like via the user.

In addition, this enables simple conversion into a partial question having simpler and more recursive (or mutually recursive) isotypic structure and also easily executing the display and testing (of completeness and soundness) of the inferring process.

Also, this enables providing sound mechanical interpretation when the head of the rule expressed in the form of embedding a variable into the natural language does not include a variable, a seamless, comprehensible, simple and united process mechanism, and explanation of a corresponding inferring process.

In addition,

claim 12 provides the processing method as claimed in any one of claims 1 to 11, comprising, in the automatic unification process or the automatic derivation process:

unifying a pattern including a variable and a Horn clause having a head part including a variable; and

returning false when the pattern and the head part do not match each other as to the fixed characters for the number of characters existing in the head or tail or the both.

This enables achieving obviously greater reduction in the calculation amount and more improvement in the process speed compared than a uniform search.

In addition,

claim 13 provides the processing method as claimed in any one of claims 1 to 12, comprising, in the automatic unification process or the automatic derivation process:

when unifying a first pattern including a variable and a Horn clause having a head part including a variable

and also the pattern and the head part match each other as for the number of fixed characters existing in the head and the tail of them,

and when whose second patterns (obtained by restricting the head part of the Horn clause with restriction information whose result of applying the body part of the Horn clause as “sub goal” in the processing method claimed in claim 5 or 6 are true) do not include a variable,

returning the result processed by using the first pattern as the “pattern” of the processing method claimed in any one of claims 2 to 4 and by using the second pattern as the “constant character string” in the same processing method.

Here, the case “(the) second patterns do not include a variable” means, in the Horn clause (rule), all variables included in the head part is “also” included in the body part and variable of the head part disappears and the head part can be regarded as the constant character string, for all variables in the body part are restricted (assigned) by the constant (the constant character string) and, as a result, all variables of the head part are restricted by the constant (the constant character string) as well.

This enables mechanical and automatic unification between the patterns including a variable and the Horn clause (the rule) having the head part including a variable in an easily user-traceable way by a simple calculation model.

Thus, by returning (converting the question) the more complicated original question (the unification of a variable and variable) to a form of picking up and returning all the solution candidates between the pattern including a variable and the head part which has come not to include (i.e., converted to the constant character strings) a variable (by each restriction information), the basic structure for overcoming the “difficulty A” is simply provided and it is easy to express as a thinking process as well. Additionally, on this “returning (or converting the question), the question is converted simply into a partial question having the simpler and recursive (or mutual recursive) isotypic structure. This enables simply executing not only visualization and testing (as to completeness, soundness, etc.) of the inferring process but also study such as modification of the rule via the user.

Eventually, the followings are provided with ease: sound mechanical interpretation in case that the head of the rule expressed in the form of embedding variable into natural language includes a variable; a seamless, comprehensible, simple and united process mechanism; and explanation of a corresponding inferring process.

In addition,

claim 14 provides the processing method as claimed in any one of claims 1 to 13, wherein a computer restricts input of a fact including a variable.

Here, fact including variable (the knowledge source that is not the rule) includes, for example, “$X is $X.” (the fact that is always true tautologically) or “$X is $Y.” (the fragile fact that is true when simply a sentence pattern matches superficially).

Restricting those to be inputted to the computer enables the calculation of the automatic unification process of the pattern (the sentence may include a variable) and the fact (the sentence not including a variable, which is the fixed character string) to be simplified and the response by the automatic process to be accelerated. This also prevents the fragile fact from easily immixing to the knowledge source.

In addition,

claim 15 provides the processing method as claimed in any one of claims 1 to 14, wherein a rule is substantially in the same form with what is called Horn clause and a computer limits a head part to include a variable that does not appear in a body part.

Here, “the computer limits the head part to include a variable that does not appear in the body part” means even if variables in all the sentences in the body part ($Y and $Z in this example) is restricted (assigned), such as the head part is “$X is nice” and the body part is “$Y is strong, $Y is kind to $Z, $Z is a child, $Y is smart”, the computer limits input, storing, and activation of such a rule as a variable in the head part ($X in this example) remains without being restricted as an information source. Such rule causes a variable of head part that is not restricted and remain as well as in the case of fact, and this may often bring the generation of the unsound inferring result and slow down the speed of inferring as well.

Restricting such rules to be inputted enables the calculation of the automatic unification process of the pattern (the sentence may include a variable) and the head part (that can be reduced to the aggregation of the sentence not including a variable, which means the fixed character string, according to claim 13) to be simplified and the response by the automatic process to be accelerated. This also prevents the fragile fact from being generated easily.

In addition,

claim 16 provides the processing method as claimed in any one of claims 1 to 13, wherein, in the automatic unification process or the automatic derivation process,

the automatic unification process of a pattern and a head part or a fact respectively having a variable that remains non-restricted

is conducted by obtaining and returning a set of solutions that are the minimum as a fixed character string.

Here, as an example of “the set of the solutions that are the minimum as the fixed character string” two solutions such as {($A=“mo”,$B=<null>,$C=<null>,$D=“ha”) and ($A=null,$B=“mo”,$C=“ha”,$D=null)} may be provided as the result of the automatic unification of “$A ha $B” and “$C mo $D”.

The example of the solution (especially a minimum and simple example) thereby can also be provided even if there are an infinite number of solutions.

In addition,

claim 17 provides the processing method as claimed in any one of claims 1 to 13, wherein, in the automatic unification process or the automatic derivation process,

the automatic unification process of a pattern and a head part or a fact respectively having a variable that is not restricted being remained,

is conducted by obtaining and returning a set of solutions that are the minimum as the character string including a variable.

Here, as an example of “the set of the solutions that are the minimum as the fixed character string” two solutions such as {($A=“$C mo”,$B=<free>,$C=<free>,$D=“ha $B”), ($A=<free>, $B=“mo $D”, $C=“$A ha”, $D=<free>)} may be provided as the result of the automatic unification of “$A ha $B” and “$C mo $D”. It may be regarded that the total (through a solution setup) of a character string length (one character per appearance of a variable when a variable is included) of the value restricting a variable (the value assigned to a variable) is the minimum.

A typical form of the solution thereby can be provided even if there are an infinite number of solutions.

In addition,

claim 18 provides the processing method as claimed in claim 16 or 17, comprising:

when a fixed character for the number of characters existing commonly in head or tail of a character string in a pattern and a head part or a fact respectively having a variable that remains non-restricted do not match each other,

returning false.

This enables avoiding the automatic search that has no possibility of the unification and accelerating the automatic process.

In addition,

claim 19 provides the processing method as claimed in claim 16 or 17, comprising:

obtaining a set of solutions to be the minimum as a fixed character string or a character string including a variable;

affirming that a variable included in both character strings (referred to as a first character string and a second character string) constituted with a pattern and a head part or a fact respectively having a variable that remains non-restricted are restricted commonly in each character string and that are restricted independently between the character strings (or defining a scope restricting a variable with the same name commonly as only in each character string (or defining the character string interval as out of the scope of the variable)); and

obtaining a set of solutions that are the minimum by a whole search for finding a case that both character strings match each other by assigning any partial character string (including <null> and a whole character string) of a corresponding character string (a second character string to a variable of a first character string, a first character string to a variable of a second character string) or itself to each variable.

“Assigning . . . or itself” means assigning “$X” itself to “$X” of the character string. In case that both of the first character string and the second character string happen to include $X (scopes thereof are different from each other), the clearly sound calculation can be conducted by even assigning those (for example, after converting to “$X1” and “$X2”) so that $X of the first character string can be distinguished from $X of the second character string.

This enables achievement of constant comprehensiveness (or completeness depending on the characteristic of the question (the pattern pair)) of the set of solutions while securing the soundness and halting (finiteness of the calculation).

In addition,

claim 20 provides the processing method as claimed in claim 19, comprising:

instead of both character strings themselves constituted with a pattern and a head part or a fact respectively having a variable that remains non-restricted,

processing the both character strings corresponding to two character strings remained after eliminating a fixed character string for the number of a characters existing commonly in a head or a tail of each character string of a pattern and a head part or a fact respectively having the variable that remains non-restricted.

This enables reducing the space of the whole search while keeping the constant comprehensiveness (or the finiteness depending on a case) of the set of solutions and thereby the process can be accelerated.

For example, as the process of unification between “i shi ka wa no $A ha $B ga su ki.” (“$A of Ishikawa likes $B”, in English) and “i shi ka wa no $C mo $D a i su ga su ki.” ($C of Ishikawa also likes $D icecream”, in English), instead of simply searching a solution, after eliminating the common parts in the head and the tail and converting to

“$A ha $B”

and

“$C mo $D a i su”,

on all the both character strings (23×23×8×8 alternations exist) resulted from

assigning all the partial character strings of “$C mo $D a i su” (in case a variable such as $C or $D (same for a variable in a ${ . . . } form as well) is considered one character, there are six characters as a whole, 6× (6+1)/2+1 (for <null>)+1 (for assigning itself)=23 alternations exist) to “$A” and “$B” respectively by the whole search, while likewise assigning all the partial character strings of “$A ha $3” (there are 3 characters as a whole, 3×(3+1)/2+1+1=8 alternations exist) to “$C” and “$D” respectively,

in case the both character strings match each other (e.g.,

(

“mo ha a i su”,
“ha mo a i su”,
“$A ha mo a i su”,
“$C mo ha a i su”,
“$A ha mo $D a i su”,
* for information, “$C mo ha $B a i su” does not match
), the aggregation of the assigning set {
($A=”mo”,$B=”a i su”,$C=<null>, $D=”ha”),
($A=<null>,$B=”mo a i su”,$C=”ha”,$D=<null>),
($A=”$A”,$B=”mo a i su”,$C=”$A ha”,$D=<null>),
($A=”$C mo”,$B=”a i su”,$C=”$C”,$D=”ha”),
($A=”$A”,$B=”mo $D a i su”,$C=”$A ha”,$D=”$D”)
} or the aggregation of the partial assigning of each

assigning set (e.g., {

($A=”mo”,$B=”a i su”),
($A=<null>,$B=”mo a i su”),
($A=”$A”,$B=”mo a i su”),
($A=”$C mo”,$B=”a i su”),
($A=”$A”,$B=”mo $D a is su)
})

can be answered as the solution.

Incidentally, in $A=“$A” or $B=“mo $D a i su”, $A or $D is free and it is possible to show that the unification can be done by assigning any character string thereto (i.e., show that there are an infinite number of solutions and show the way to limit (like in a regular expression form) the infinite number of solutions (or character strings)).

In addition,

claim 21 provides the processing method as claimed in claim 19 or 20, wherein:

obtaining a set of solutions that are the minimum by a whole search for searching a case that both character strings match each other by assigning any partial character string (including <null> and a whole character string) of a corresponding character string or itself to each variable,

conducting the whole search for searching a case that the both character strings match each other while replacing the variable included in the partial character string with a new variable that has not yet appeared in both character strings, and also assigns to the new variable in the same way recursively thereafter when a variable is included in the partial character string that is assigned to the variable.

This enables the comprehensiveness of list-up of the solution candidates to be enhanced more while keeping the soundness of the solution search about the question (e.g., in case that both character strings={“$X ha $X”, “i $Y u”}, ($=“i u” $Y=“u ha i”) should be listed up as the solution candidates) have a characteristic that requires to search also the solution obtained by assigning the fixed character in own character string to a variable in own character string reflexively through a variable in the corresponding character string. In the above example, it is possible to show that the solution candidates ($X=“i u”, $Y=“u ha i”) can be listed up from the both character strings (also referred to as “pattern pair”)={“$X ha $X”, “i u”} by the fact that the present invention can recursively generate search branches such as ($X=“i $ {Y1} u”)→($ {Y1}=<null>→($Y=“u ha i”) (a part of a search tree and can be generated for limited times in case of a width-first search according to the present invention).

“whole search . . . recursively” means, for example, listing up a corresponding assigning series (e.g., listing above ($X=“i ${Y1} u”→(${Y1}=<null>)→($Y=“u ha i”)), while conducting the width-first search repeating each possible assignment (same as the former claims) to each variable recursively. A variation of the first assignment will be 2×(7×(7+1)/2+1+1)+3×(6×(6+1)/2+1+1)=60+69=129 alternations in case that the type of a variable in the both character strings are 2 and 3 respectively and the length of the character strings are 6 characters and 7 characters respectively (variables are counted as one character). In case that the width-first search is conducted so that the maximum depths of further branches derive from such branch are equal, the search in every single time can be limited to an appropriate calculation amount (securing halting or response speed that has come to be unguaranteed due to the recursiveness) by providing a limiter by assigning times for example (such as a program step for comparing to an upper limit). Incidentally, in case of the depth-first search, the calculation amount can be limited by depth limitation, the assignment time or the like. In any case, an infinite loop by own recursion or mutual recursion can be evaded by providing the stack structure (or arrangement of the structure) or the like managing a call of a recursive function to compare a call parameter (which may include status expression of the both character strings according to the assigning series (assigning context)) of an ancestor (closer to a root) branch to a current call parameter, for example. In addition, the branches that cannot be unified can be pruned on a basis of whether the fixed character strings existing in the head and the tail of the both character strings match each other for the number of the characters existing commonly. Yet, the computer may respond to the user indicating search accuracy such as “no solution (accuracy: a million assignments and search depth is within 20)” when no solution is found by the search of the limited calculation amount and as “($X=“i u”, $Y=“u ha i”), ( . . . ), . . . ((accuracy: a million assignments and search depth is within 20) ”when found. Also, in case that the whole search can be conducted undoubtedly within the limited number of the assignment and within the limited search depth (in case there is completeness), the computer can respond to the user indicating so as “no solution (the whole search has been done)” or “($X=“i u”, $Y=u ha i”), ( . . . ), . . . (the whole search has been done)”, or the like.

In addition,

claim 22 provides the processing method as claimed in any one of claims 19 to 21, wherein

on a result of assignment to a variable, two character strings left by eliminating a fixed character for the number of a characters existing in a head and a tail of each character string from the both,

are regarded as a “corresponding character string” to be a subject of “any partial character string in corresponding character string (including <null> and the whole character string”, and the number of the fixed characters existing in the head or tail of the character string is reduced as the search proceeds.

This enables cutting the calculation amount, for the number of the branches is reduced as the search proceeds (goes closer to the end of branches).

In addition,

claim 23 provides the processing method as claimed in claim 16 or 17, comprising:

obtaining a set of solutions to be the minimum as a fixed character string or a character string including a variable;

affirming that each variable included in both character strings (referred to as a first character string and a second character string) constituted with a pattern and a head part or a fact respectively having a variable that remains non-restricted is restricted commonly in each character string and also that the variable is restricted independently between the character strings (or defining a scope restricting the variable with the same name commonly as only in each character string (or defining the character string interval as out of the scope of the variable));

obtaining a set of solutions by assigning recursively the fixed character string (including the null character) or the character string including a variable to each variable;

confining a variable tried to be assigned to a variable of a corresponding head or tail of own character string in which the head or the tail of the corresponding character string is the fixed character;

defining an assignment value as a new variable following the fixed character or fixed character string of the head or <null> in case the fixed character is the head, and as the fixed character or fixed character string of the tail following the new variable or <null> in case the fixed character is the tail; and

on a result of assigning to a variable, repeating elimination of the fixed character for the number of the characters existing commonly in the head or tail of each character string from the both.

This enables confining the listing range of the solution considerably (without degrading the comprehensiveness of the search) and paying attention to the existence of the fixed character in the head or tail at the same time. This makes it possible to cut the calculation amount and to accelerate the search considerably.

In addition,

claim 24 provides the processing method as claimed in claim 16 or 17, comprising:

obtaining a set of solutions to be the minimum as a fixed character string or a character string including a variable,

affirming that each variable included in both character strings (referred to as a first character string and a second character string) constituted with a pattern and a head part or a fact respectively having a variable that remains non-restricted is restricted commonly in each character string and also that the variable is restricted independently between the character strings (or defining a scope restricting the variable with the same name commonly as only in each character string (or defining the character string interval as out of the scope of the variable));

obtaining a set of solutions by assigning recursively the fixed character string (including the null character) to each variable;

obtaining restriction information generated by using only a fixed character type, which is a character type from which a variable identifier or a delimiter is eliminated, in the both character strings that are acquired as a result of eliminating a common fixed character for the number of characters existing in the head and the tail of each character string by listing up from a smallest total of the character string length of the restricting value.

This enables reaching the solution efficiently and listing up for the question having a specific characteristic.

In addition,

claim 25 provides the processing method as claimed in claims 19 to 24, comprising:

on a basis of an obtained “set of solutions to be the minimum as a character string including a variable”,

continuing search by a Horn clause generated by rewriting a variable of the Horn clause with a character string including a variable temporarily.

This enables passing on the constraint calculated necessary for unification of the pattern and the head part of the Horn clause (the rule) (in the example above, there may be an unification policy such that the constraint that a variable “$C” can be unified only by being restricted (assigned) with a character string in the form of “$A ha” works (e.g., in case of the last assigning set of the above example)) to the search process of the body part of the Horn clause and thereby to streamline the search.

In addition,

claim 26 provides the processing method as claimed in any one of Clams 19 to 25, comprising:

on a basis of an obtained “set of solutions to be the minimum as a character string including a variable”,

the processing method returns a set of fixed character string setups generated by assigning an element of a set of a fixed character string setups predefined as a set of the solution setups of “a fact including a variable” to a variable part of “a character string including a variable”.

This enables conducting the solution search cooperating efficiently with a database connecting the fact including a variable (one or plural) and the set of the proper answers (or hypotheses) that can be embedded to a variable (e.g., the knowledge source in “Kotoba Hoteishiki (registered trademark)”, “VLANK (registered trademark)”). Also, this enables managing a good deal of fact having the similar sentence form efficiently in cooperation with the structure of the present invention.

In addition,

claim 27 provides the processing method as claimed in any one of claims 1 to 26, comprising, in the automatic unification process or the automatic derivation process:

when conducting an automatic unification of a first pattern including a variable and a second pattern including a variable,

in case that a fixed character for the number of characters existing in a head and a tail of both patterns match each other, and the same variable appears only once in each pattern,

returning information indicating the existence of infinite number of solutions.

In addition,

claim 28 provides a device for conducting the method claimed in any one of claims 1 to 27.

In addition,

claim 29 provides a computer program for a computer to conduct the method claimed in any one of claims 1 to 27.

### Effect of the Invention

The effect of the present invention is as mentioned above on each claim.

### BRIEF DESCRIPTION OF THE DRAWINGS

FIG. 1 is a general view of the network system conducting the present invention most effectively (Embodiment 1);

FIG. 2 is a schematic diagram showing a hardware structure of a computer implementing the present invention (Embodiment 1); and

FIG. 3 is a schematic diagram showing an example of a screen display of a terminal implementing the present invention (Embodiment 1).

### DESCRIPTION OF EMBODIMENTS

The present invention can be implemented by a computer in any kind (e.g., cloud server, large multi-purpose machines, desk top computers, laptops, mobile devices, machines for the exclusive use for the present invention), regardless of whether connected/unconnected with the network. Yet here an embodiment realized by a computer having a general multi task function and a window function, which is connected with the internet, is explained hereafter.

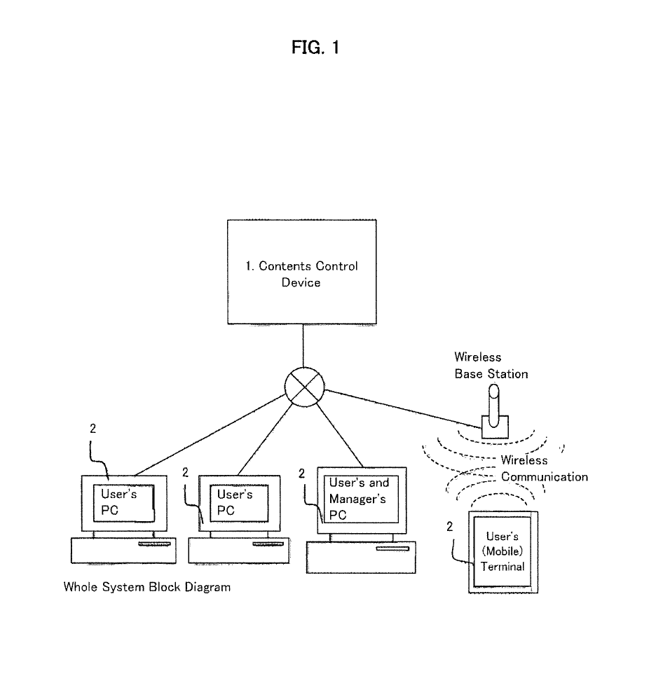

FIG. 1 is a general view of the network system implementing the present invention most effectively. A content managing device 1 can be a publicly-known file sharing server which receives a post of the content (the rule or the fact) handled by the present invention with a user's PC 2 or a user's and manager's PC 2 and also delivers the content while controlling a sharing access right or a priority of the content supply through a determined policy. The user's PC 2 may be a computer, including mobile device, which inputs and stores the content (the rule or the fact) each user believes (or the content each user wants to consider about) expressed in the natural language in accordance with the method of the present invention, and which processes it by the method of the present invention.

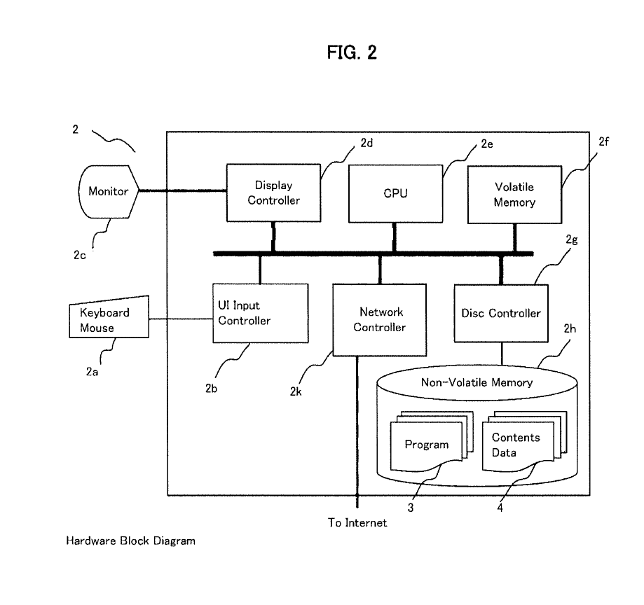

FIG. 2 is a schematic diagram showing a hardware structure of the computer implementing the present invention. This is a typical one as the structure of a computer. Features of the present invention are the content processed in a CPU 2e by using a natural law in accordance with instructions or descriptions of programs 3 and a content data 4 stored in a nonvolatile memory 2h and a manner of a dialog protocol (or a format) with the user.

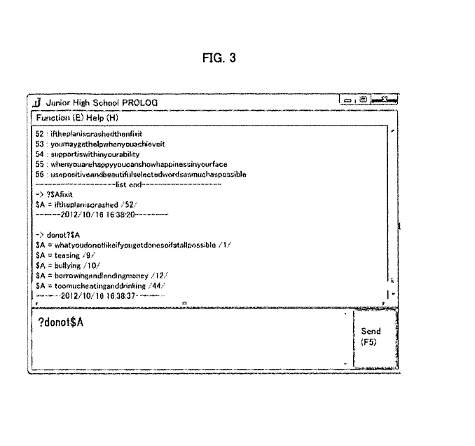

FIG. 3 is a schematic diagram showing an example of a screen display of a terminal implementing the present invention. In FIG. 3, for a question (of open question) “?$A shi na i” (“do not do $A”, in English), the computer lists up the answers “$A=sa re te i ya na ko to ha na ru be ku/1/” (“what you do not like if you get done as possible/1/”, in English) using the fact “sa re te i ya na ko to ha na ru be ku shi na i” (“do not what you do not like if you get done as possible”, in English) in line 1 of a stored list L that is not shown, and answers “$A=i ji me wo/9/” (“$A=bully/9/”, in English) by using the fact “i ji me wo shi na i” (“do not bully”, in English) in line 9 of the list L.

In such embodiment, the computer program produced via such languages as the C++ language enables a computer, including a personal computer, to conduct a variety of possible actions. For this, a method to realize a known basic operation of the computer using the natural law (such as storing and extraction to a register, a memory or a storage, a four-function calculation, and a comparison) and a general function that has already been a standard library of a development environment (which includes: assignment, comparison and copy to a variable or an n-dimensional arrangement; operation/comparison/display of the character string or the numerical value; operation of a list structure, a queue structure, a hash structure, a vector type or the like; a binary search or a sorting operation; a pattern matching operation by a regular expression; a network communication operation) are not described here in detail, for they are not an essence of the present invention (a unique structure relating to the novelty or the inventive step) and have been known to those skilled in the art. On the other hand, it is described in detail hereinafter about an operation order or a memory method (an algorithm or a data structure) for achieving the unique process of the present invention by combining those general functions. Through the explanation of the algorithm or the like and by providing the explanation of the solution for the problem mentioned above and the explanation of the drawings of the preset invention for reference to the development, a professional programmer of standard level is definitely able to use the computer to implement the method of the present invention by using a standard application program development technique (a GUI application integrated development environment or the like by the C++ language) and also is able to produce a device or a program for the method.

The algorithm shown below is based on a standard structuring programming which, after newly defining a desired “function” by some language including the C language/C++ language or the like, call the function. Those skilled in the art are able to realize a processing means (a program or a calculator) corresponding to a solution of the present invention, while separating inputs, outputs or functions according to functional division of each function below (or by coding the function group as they are according to the design indicated below).

▪ A processing algorithm design of a

knowledge list L for an inquiry P
======================================================
=======================================
A function Q1 (P: the pattern that may include a variable, L:
the knowledge list) :★Embodiment 1 of a main function in common
for all the claims★

{

| | |
|---|---|
| 1. | A content B of the first row (the fact or the Horn clause) |

of L is taken out. In case that L is null (which means that the
first row cannot be taken out), false is outputted and the
process is terminated.

| | |
|---|---|
| 2. | The first initial value of the restriction information |

C of variables is regarded as null, the below-mentioned function
H (P, B, C) is called and the restriction information (= the
set of solutions) C that takes true (which means matched) is
outputted.

| In case of true (matched), | |
|---|---|
| | true (yes) is outputted (along with the row number of the |
| matched content B). | |
| In case of false, | |
| | nothing is done. |
| 3. | In case that a content B′ of the next row of L |

exists,

• B←B′ is defined and the process moves to 2,

if dose not exist,

• false (no) is outputted, when true is not outputted at

all in 2,

• and the process is terminated.

}

▪ The processing algorithm design of the knowledge

list L for the inquiry P (a prior fixed-stringizing version)
======================================================
=======================================
A function Q2 (P: the pattern that may include variables, L:
the knowledge list) :★Embodiment 2 of a main function in common
for all the claims★

{

(Prior Fixed-Stringizing)

1. A fixed character string text T having {all the character strings that can be deducted only from L/set of row numbers of L applied as the basis for deducing each character string} for its each row, is obtained.

Specifically, the text T in which the element of an output sequence (A=solution1/argument1, A=solution2/argument2, . . . ) of the above-mentioned function Q1 (“$A”, L) is merged for each row, is obtained.

In case that the process lapses into an endless loop in obtaining the text T, the deduction is partially abbreviated by an endless loop detecting function using such as an explicit call management stack.

For example, when a true-or-false check of the Horn clause is being done by the computer under certain variable restriction condition,

whether the true-or-false of the same Horn clause is about to be checked under the same variable restriction condition or not

is monitored by managing the call management stack having the structure (the Horn clause identifier being checked, the current variable restriction condition) as members, and

linear search is conducted to check whether there is the same combination toward the root of the stack when calling

to detect the endless loop.

(The set of solutions is obtained by a method (function F) simpler than Q1 since this is only for the fixed character string)

2. All C in that the below function F (P, t, C) is true is outputted for every row t of the text T.

(Output of the Final Result)

3. True is outputted if there is even only one C, and the false is outputted if there is no C.

### INDUSTRIAL APPLICABILITY

The present invention is applicable to education of the predicate logic for a range from junior-high-school students (or those at around their age) to adults and also is applicable to management, exchange, and share of public knowledge and information. This application is also true for a test of the validity of sets consisting of facts (may include opinions) and rules, which can be philosophies or mindset).

### REFERENCE SIGNS LIST

1 Content Control Device
2 User's PC or a PC of both of User's and Manager's
3 Program of the present invention
4 Content Data (Aggregation Set of Rule or Fact)

1. A processing method for causing a computer to automatically execute all of or a part of a function of a logic programming language PROLOG, the method comprising:
manually inputting “fact”, “rule” or “goal” of PROLOG to the computer in discerning a constant part and a variable part corresponding to “literal” of PROLOG (referred as “sentence” hereafter) by a character type, a delimiter or an escape character; and
by computer, executing an automatic unification process, an automatic derivation process or both of them in the sentence included in the input of the “fact”, “rule” or “goal”, handling a variable as what may straddle a boundary of a subject clause, a predicate clause, a subject, a predicate, an object, a complement, a modifier of an inflectable word or a sentence.

2. The processing method as claimed in claim 1, comprising, in the automatic unification process:
recursively repeating a unification of patterns (whose constant part and variable part are distinguished by a character type, a delimiter or an escape character) as sentences that may include variables and a sentence that does not include variables until it comes to have no variable in a constant manner;
calculating a longest matching solution (ex. TaroandJiro) of the variable (ex. $X) that appears in the pattern (ex. $Xand$Ylike$Z) firstly (or lastly), followed by storing each status ($X=TaroandJiro>TaroandJi>Taroand>Taro>Ta>Null) of the solutions, which is a base condition to generate a new pattern, as to each of the new pattern (ex. “TaroandJiroand$Ylike$Z”>“TaroandJiand$Ylike$Z”>“TaroAndand$Ylike$Z”>“Taroand$Ylike$Z”>“Taand$sYlike$Z”>“and$Ylike$Z”) obtained by assigning the process (ex. “TaroandJiro>TaroandJi>TaroandJi>Taroand>Taro>Ta>Null) eliminating characters of the character string of the longest matching solution from its rear (or its beginning) to a null character in the eliminating process; and
obtaining different answers (e.g., Answer 1=($X=TaroandJiro, SY=Sabro), answer 2=($X=Taro, SY=JiroandSaburo) of different unifications by integrating the status of each unified halfway solution (e.g., truth ($X=TaroandJiro, $Y=Saburo), truth ($X=Taro, $Y=JiroandSaburo)) when there is no more variable.

3. The processing method as claimed in claim 2, comprising:
gradually eliminating characters just until a shortest matching solution obtained separately, instead of gradually reducing to the null character.

4. The processing method as claimed in claim 2, comprising:
gradually eliminating until the character gets null;
gradually eliminating the characters until the character gets null and the longest matching solution includes one character C that is a fixed character appearing just after (or just before) the variable appears first (or last) in the pattern; and
eliminating partial character strings ranging from the last (or first) to the first C met of the longest matching solution, including the C;
wherein this one character C is the first (or the last) character C of the solution candidate that is assigned to the other variable as a solution candidate when the character appearing just after (or just before) is the other variable and the solution is not a null character.

5. The processing method as claimed in claim 1, comprising, in the automatic unification process or the automatic derivation process:
obtaining a restriction information that is the “goal” (including a “sub goal”, the same applying hereafter);
obtaining the restriction information about each sentence constituting the “goal” independently; and
giving a return value true and its product set when the product set of each restriction information is not empty.

6. The processing method as claimed in claim 1, comprising, in the automatic unification process or the automatic derivation process:
obtaining a restriction information that is “goal”;
defining an existing restriction information as null first;
reducing recursively a sentence aggregation included in the “goal”, by executing an automatic calculation regarding whether the one sentence can be true under application of an existing restriction information and also additional restriction information to be true;
eliminating the one sentence while adding the additional restriction information to the existing restriction information; and
defining the existing restriction information as “goal” when the sentence aggregation keeping possibility to be true turns to an empty set.

7. The processing method as claimed in claim 1, comprising, in the automatic unification process or the automatic derivation process:
unifying the pattern not including a variable and the fact not including a variable;
returning true when the pattern and the fact match each other as a character string; and
returning false when the pattern and the fact do not match each other as a character string.

8. The processing method as claimed in claim 1, comprising, in the automatic unification process or the automatic derivation process:
unifying the pattern not including a variable and the fact not including a variable;
when the pattern and the fact match each other as a character string, returning the result of application of processing method wherein defining body part of the Horn clause as the sub goal; and
when the pattern and the fact do not match each other as a character string, returning false.

9. The processing method as claimed in claim 1, comprising, in the automatic unification process or the automatic derivation process:
unifying a pattern not including a variable and a Horn clause having the head part including a variable;
on each restriction information obtained by using the pattern as the “constant character string” in the processing method and using the head part as the “pattern” in the same processing method,
returning true when what can be true exists after the restriction information is applied to the body part of the Horn clause and the resulted body is processed as “sub goal” of the processing method; and
returning false if not.

10. The processing method as claimed in claim 1, comprising, in the automatic unification process or the automatic derivation process:
unifying a pattern including a variable and a fact not including a variable; and
returning a result processed by executing processing by using the pattern as the “pattern” in the processing method and by using the fact as the “constant character string” in the same processing method.

11. The processing method as claimed in claim 1, comprising, in the automatic unification process or the automatic derivation process:
unifying a pattern including a variable and a Horn clause having a head part not including a variable;
returning true together with restriction information (C)
in case that the restriction information (C) exists which takes a true result processed by
using said pattern as the “pattern” in the processing method, and
using the head part as the “constant character string” in the same processing method,
and that the result processed by taking the body part of the Horn clause as “sub goal” of the processing method is true.

12. The processing method as claimed in claim 1, comprising, in the automatic unification process or the automatic derivation process:
unifying a pattern including a variable and a Horn clause having a head part including a variable; and
returning false when the pattern and the head part do not match each other as to the fixed characters for the number of characters existing in the head or tail or the both.

13. The processing method as claimed in claim 1, comprising, in the automatic unification process or the automatic derivation process:
when unifying a first pattern including a variable and a Horn clause having a head part including a variable and also the pattern and the head part match each other as for the number of fixed characters existing in the head and the tail of them,
and when whose second patterns (obtained by restricting the head part of the Horn clause with restriction information whose result of applying the body part of the Horn clause as “sub goal” in the processing method are true) do not include a variable,
returning the result processed by using the first pattern as the “pattern” of the processing method and by using the second pattern as the “constant character string” in the same processing method.

14. The processing method as claimed in claim 1, wherein a computer restricts input of a fact including a variable.

15. The processing method as claimed in claim 1, wherein a rule is substantially in the same form with what is called Horn clause and a computer limits a head part to include a variable that does not appear in a body part.

16. The processing method as claimed in claim 1, wherein, in the automatic unification process or the automatic derivation process,
the automatic unification process of a pattern and a head part or a fact respectively having a variable that remains non-restricted,
is conducted by obtaining and returning a set of solutions that are the minimum as a fixed character string.

17. The processing method as claimed in claim 1, wherein, in the automatic unification process or the automatic derivation process,
the automatic unification process of a pattern and a head part or a fact respectively having a variable that is not restricted being remained,
is conducted by obtaining and returning a set of solutions that are the minimum as the character string including a variable.

18. The processing method as claimed in claim 16, comprising:
when a fixed character for the number of characters existing commonly in head or tail of a character string in a pattern and a head part or a fact respectively having a variable that remains non-restricted do not match each other,
returning false.

19. The processing method as claimed in claim 16, comprising:
obtaining a set of solutions to be the minimum as a fixed character string or a character string including a variable;
affirming that a variable included in both character strings (referred to as a first character string and a second character string) constituted with a pattern and a head part or a fact respectively having a variable that remains non-restricted are restricted commonly in each character string and that are restricted independently between the character strings (or defining a scope restricting a variable with the same name commonly as only in each character string (or defining the character string interval as out of the scope of the variable)); and
obtaining a set of solutions that are the minimum by a whole search for finding a case that both character strings match each other by assigning any partial character string (including <null> and a whole character string) of a corresponding character string (a second character string to a variable of a first character string, a first character string to a variable of a second character string) or itself to each variable.

20. The processing method as claimed in claim 19, comprising:
instead of both character strings themselves constituted with a pattern and a head part or a fact respectively having a variable that remains non-restricted,
processing the both character strings corresponding to two character strings remained after eliminating a fixed character string for the number of a characters existing commonly in a head or a tail of each character string of a pattern and a head part or a fact respectively having the variable that remains non-restricted.

21. The processing method as claimed in claim 19, wherein:
obtaining a set of solutions that are the minimum by a whole search for searching a case that both character strings match each other by assigning any partial character string (including <null> and a whole character string) of a corresponding character string or itself to each variable;
conducting the whole search for searching a case that the both character strings match each other while replacing the variable included in the partial character string with a new variable that has not yet appeared in both character strings, and also assigns to the new variable in the same way recursively thereafter when a variable is included in the partial character string that is assigned to the variable.

22. The processing method as claimed in any one of claim 19, wherein
on a result of assignment to a variable, two character strings left by eliminating a fixed character for the number of a characters existing in a head and a tail of each character string from the both,
are regarded as a “corresponding character string” to be a subject of “any partial character string in corresponding character string (including <null> and the whole character string”, and the number of the fixed characters existing in the head or tail of the character string is reduced as the search proceeds.

23. The processing method as claimed in claim 16, comprising:
obtaining a set of solutions to be the minimum as a fixed character string or a character string including a variable;
affirming that each variable included in both character strings (referred to as a first character string and a second character string) constituted with a pattern and a head part or a fact respectively having a variable that remains non-restricted is restricted commonly in each character string and also that the variable is restricted independently between the character strings (or defining a scope restricting the variable with the same name commonly as only in each character string (or defining the character string interval as out of the scope of the variable));
obtaining a set of solutions by assigning recursively the fixed character string (including the null character) or the character string including a variable to each variable;
confining a variable tried to be assigned to a variable of a corresponding head or tail of own character string in which the head or the tail of the corresponding character string is the fixed character;
defining an assignment value as a new variable following the fixed character or fixed character string of the head or <null> in case the fixed character is the head, and as the fixed character or fixed character string of the tail following the new variable or <null> in case the fixed character is the tail; and
on a result of assigning to a variable, repeating elimination of the fixed character for the number of the characters existing commonly in the head or tail of each character string from the both.

24. The processing method as claimed in claim 16, comprising:
obtaining a set of solutions to be the minimum as a fixed character string or a character string including a variable,
affirming that each variable included in both character strings (referred to as a first character string and a second character string) constituted with a pattern and a head part or a fact respectively having a variable that remains non-restricted is restricted commonly in each character string and also that the variable is restricted independently between the character strings (or defining a scope restricting the variable with the same name commonly as only in each character string (or defining the character string interval as out of the scope of the variable));
obtaining a set of solutions by assigning recursively the fixed character string (including the null character) to each variable;
obtaining restriction information generated by using only a fixed character type, which is a character type from which a variable identifier or a delimiter is eliminated, in the both character strings that are acquired as a result of eliminating a common fixed character for the number of characters existing in the head and the tail of each character string by listing up from a smallest total of the character string length of the restricting value.

25. The processing method as claimed in claim 19, comprising:
on a basis of an obtained “set of solutions to be the minimum as a character string including a variable”,
continuing search by a Horn clause generated by rewriting a variable of the Horn clause with a character string including a variable temporarily.

26. The processing method as claimed in claim 19, comprising:
on a basis of an obtained “set of solutions to be the minimum as a character string including a variable”,
the processing method returns a set of fixed character string setups generated by assigning an element of a set of a fixed character string setups predefined as a set of the solution setups of “a fact including a variable” to a variable part of “a character string including a variable”.

27. The processing method as claimed in claim 1, comprising, in the automatic unification process or the automatic derivation process:
when conducting an automatic unification of a first pattern including a variable and a second pattern including a variable,
in case that a fixed character for the number of characters existing in a head and a tail of both patterns match each other, and the same variable appears only once in each pattern,
returning information indicating the existence of infinite number of solutions.

28. A device for executing the method claimed in claim 1.

29. A computer program for causing a computer to execute the method claimed in claim 1.
